(19) United States
(12) Patent Application Publication
(10) Pub. No.: US 2006/0110285 A1
(43) Pub. Date: May 25, 2006

(54) Sample receiving device and methods of use thereof

(76) Inventors: Roger N. Piasio, Cumberland, ME (US); Denis J. Boissonneault, Portland, ME (US)

Correspondence Address: T. D. FOSTER, 12760 HIGH BLUFF DRIVE, SUITE 300, SAN DIEGO, CA, 92130, US

(21) Appl. No.: 11/244,996

(22) Filed: Oct. 6, 2005

Related U.S. Application Data
(60) Provisional application No. 60/616,385, filed on Oct. 6, 2004.

(51) Int. Cl. G01N 31/22

(52) U.S. Cl. 422/56

(57) ABSTRACT

One or more of the present embodiments relate to sample receiving devices and methods of use thereof for the collection and testing of test samples, where the collection of the test sample(s) and the testing of the test sample(s) are separate activities and utilize separate parts of the receiving test device. One or more of the present embodiments are particularly adaptable as a test receiving member, which can be taken home by a patient for collection of a desired sample and later sent or taken to a testing facility where the sample receiving member can be connected to a testing member by way of a releasable hinge whereby the test sample can be tested to yield the test result. One or more of the present embodiments can be combined with any test methodology where a test sample is required to be provided and then separately tested to yield the test result.

### FIELD OF INVENTION

One or more of the present embodiments relate generally to the field of test sample receiving devices, and particularly to transportable sample receiving devices and methods of use thereof

### BACKGROUND OF THE INVENTION

A variety of test sample receiving devices for collection and testing of various samples are commercially available. These sample receiving devices can be used to receive and collect samples of different kinds for testing, such as for example, collection of biological fluids or excrements.

Many of the available sample receiving devices are prone to human error and are inefficient when a patient is required to collect the sample personally in his/her home. Oftentimes the sample needed to be collected and later tested is a biological fluid or excrement, the collection of which may cause a certain degree of stress on a patient who is trying to collect such a sample. While there has been a trend to produce more effective and efficient test sample receiving devices, further improvements for effectiveness and ease of collecting a sample, especially by a patient in a home setting are desirable, and one or more of the present embodiments address the existing problems and provides related benefits.

### SUMMARY OF THE INVENTION

One or more of the present embodiments relate to a sample receiving device and methods of use thereof for the collection and testing of test samples, where the collection of the test sample(s) and the testing of the test sample(s) are separate activities and utilize separate parts of the receiving test device. One or more of the present embodiments are particularly adaptable as a test receiving device, which can be taken home by a patient for collection of a desired sample and later sent or taken to a testing facility where the test sample can be tested to yield the test result. One or more of the present embodiments can be combined with any test methodology where a test sample is required to be provided and then separately tested to yield the test result.

One or more of the present embodiments recognize that sample receiving devices for collection of samples can be made more user-friendly, effective and efficient by separating the sample receiving and collection aspect of testing from the actual testing procedure. One or more of the present embodiments can be adapted to receive a test sample where the test sample can be tested within a short period of time by bringing the test sample receiving member of one or more of the present embodiments in liquid communication with the testing member of one or more of the present embodiments together with any solvent or other desired testing material or component in order to perform the testing of the collected sample. One or more of the present embodiments can also be adapted to receive a test sample by a patient at his/her home where the test sample receiving member is taken home by the patient and then brought or sent to a laboratory where the test sample receiving member is brought in liquid communication with the testing member together with any solvent or other desired testing material or component in order to perform the testing of the collected sample.

A first aspect of one or more of the present embodiments includes a transportable sample receiving device including a sample receiving member having one or more sample application pads able to accept one or more samples suspected of containing one or more analytes of interest; and a testing member having one or more test elements capable of detecting the one or more analytes of interest, the testing member being able to opposingly engage the sample receiving member; wherein, when the sample receiving member is brought into opposition with the one or more testing members, the one or more sample application pads of the sample receiving member are brought into liquid communication with the one or more testing elements of the testing member.

A second aspect of one or more of the present embodiments includes a transportable sample receiving device including means for receiving a sample suspected of containing one or more analytes of interest; and means for testing the sample, capable of detecting the one or more analytes of interest, the means for testing able to opposingly engage the means for receiving a sample by means of a releasable hinge; wherein, the means for receiving a sample and the means for testing the sample are able to opposingly engage one another such that when the means for receiving a sample and the means for testing the samples are brought into opposition, the means for receiving a sample is brought into liquid communication with the means for testing said sample.

A third aspect of one or more of the present embodiments includes a method for detecting one or more analytes of interest in a sample suspected of containing one or more analytes of interest including the steps of a) providing a separable and opposable sample receiving member comprising one or more sample application pads; b) applying the sample to the one or more sample application pads; c) providing a separable and opposable testing member including one or more immunochromatographic test strips, wherein the separable and opposable testing member is able to opposingly engage the separable and opposable sample receiving member by means of a releasable hinge; d) bringing the sample receiving member and the testing member into opposition such that the one or more sample application pads of the sample receiving member are brought into liquid communication with the one or more immunochromatographic test strips of the testing member and e) determining the presence or absence of or measuring the amount of the one or more analytes of interest in the sample.

### BRIEF DESCRIPTION OF THE DRAWINGS

FIG. 1 shows views of the front, the back, and the side of the sample receiving member of one of the present embodiments.

FIG. 2 shows a front view of the sample receiving member of one of the present embodiments having a female connector able to receive the male connector of the testing member.

FIG. 3 show a front view of the testing member of one of the present embodiments having a hinged male connector able to engage the female connector of the sample receiving member.

FIG. 4 shows a front view of one of the present embodiments including the sample receiving member having a female connector and the testing member having a male connector engaged to one another by means of a detachable hinge.

FIG. 5 shows a front view of one of the present embodiments in the closed position wherein the test result can be seen through the test result viewing aperture of the sample receiving member.

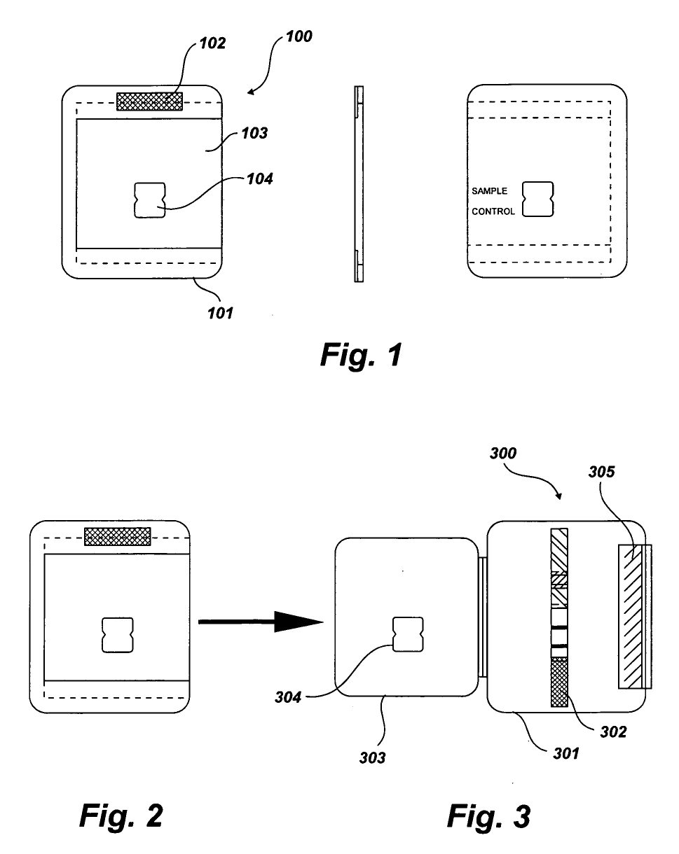

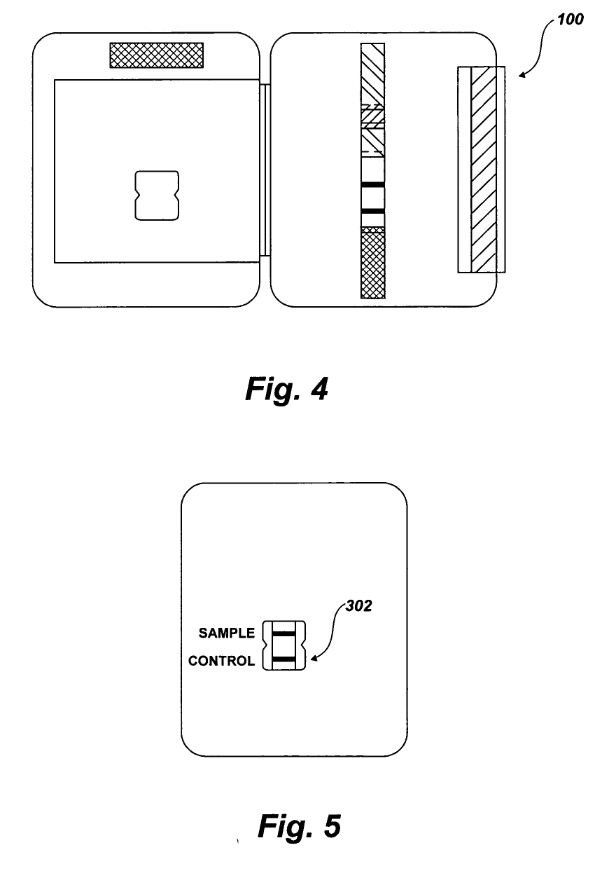

### DETAILED DESCRIPTION OF THE INVENTION

Introduction

One or more of the present embodiments recognize that sample receiving devices for collection of samples can be made more user-friendly, effective and efficient by separating the sample receiving and collection aspect of testing from the actual testing procedure.

As a non-limiting introduction to the breadth of one or more of the present embodiments, one or more of the present embodiments include several general and useful aspects, including:

1. A transportable sample receiving device including:
a sample receiving member having one or more sample application pads able to accept one or more samples suspected of containing one or more analytes of interest; and
a testing member having one or more test elements capable of detecting the one or more analytes of interest, the testing member able to opposingly engage the sample receiving member;
wherein, when the sample receiving member is brought into opposition with the testing member, the one or more sample application pads of the sample receiving member are brought into liquid communication with the one or more testing elements of the testing member.

2. A transportable sample receiving device including:
means for receiving a sample suspected of containing one or more analytes of interest; and
means for testing the sample capable of detecting the one or more analytes of interest, the means for testing able to opposingly engage the means for receiving a sample by means of a releasable hinge;
wherein, the means for receiving a sample and the means for testing the sample are able to opposingly engage one another such that when the means for receiving a sample and the means for testing the samples are brought into opposition, the means for receiving a sample is brought into liquid communication with the means for testing the sample.

3. A method for detecting one or more analytes of interest in a sample suspected of containing one or more analytes of interest including the steps of:
a) providing a separable and opposable sample receiving member having one or more sample application pads;
b) applying the sample to the one or more sample application pads;
c) providing a separable and opposable testing member having one or more immunochromatographic test strips, wherein the separable and opposable testing member is able to opposingly engage the separable and opposable sample receiving member by means of a releasable hinge;
d) bringing the sample receiving member and the testing member into opposition such that the one or more sample application pads of the sample receiving member are brought into liquid communication with the one or more immunochromatographic test strips of the testing member; and
e) determining the presence or absence of or measuring the amount of said one or more analytes of interest in said sample.

Further objectives and advantages of one or more of the present embodiments will become apparent as the description proceeds and when taken in conjunction with the accompanying drawings. To gain a full appreciation of the scope of one or more of the present embodiments, it will be further recognized that various aspects of one or more of the present embodiments can be combined to make desirable embodiments of the invention.

Unless defined otherwise, all technical and scientific terms used herein have the same meaning as commonly understood by one of ordinary skill in the art to which this invention belongs. Where a term is provided in the singular, the inventor also contemplates the plural of that term. The nomenclature used herein and the procedures described below are those well known and commonly employed in the art.

I. A Sample Receiving Device

One or more of the present embodiments relate to a sample receiving device and methods of use thereof for the collection and testing of test samples, where the collection of the test sample(s) and the testing of the test sample(s) are separate activities and utilize separate parts of the receiving test device.

One or more of the present embodiments include transportable sample receiving device including a sample receiving member comprising one or more sample application pads able to accept one or more samples suspected of containing one or more analytes of interest. The sample receiving member can be constructed in any way, wherein a sample can be applied on one or more sample application pads. The sample receiving member may be very simple and only include the one or more sample application pads, but preferably, the sample receiving member provides a moisture-resistant backing onto which the sample application pads are fixedly attached. The one or more sample application pads may be made of any material able to accept a sample and the selection of the material depends on the type of sample which is to be applied to the sample application pads. Preferably, the one or more sample application pads are made of one or more porous materials that can accept liquid, semisolid, and solid samples. Suitable porous material for constructing the one or more sample application pads include for example, nitrocellulose, filter paper, porous plastics, or glass fiber.

One or more of the present embodiments also include a testing member including one or more test elements capable of determining the presence or absence of or measuring the amount of the one or more analytes of interest. The test elements may be provided in a variety of embodiments, and one skilled in the art will recognize that the test element may be provided in an array of alternatives embodiments. The testing member may be very simple and only include one or more test members, but preferably, the testing member provides a moisture-resistant backing onto which the testing elements are fixedly attached. Preferably, the testing member is able to opposingly engage the sample receiving member, wherein, when the sample receiving member is brought into opposition with the testing member through manual closure, the one or more sample application pads of the sample receiving member are brought into liquid communication with the one or more testing elements of the testing member with sufficient applied pressure to transfer liquid from the sample application pads to the test elements.

In a preferred embodiment, the sample receiving member includes a planar sample receiving panel having a front side and a rear side wherein the one or more sample application pads are fixedly positioned on the front side of the sample receiving panel, and wherein the testing member includes a planar testing panel having a front side and a rear side wherein the testing element is fixedly positioned on the front side of the testing panel. The sample receiving panel and the testing panels are preferably flexible and moisture resistant. The panels may be made of any suitable material, such as for example, flexible coated paper or plastics. Preferably, the sample receiving panel and the testing panel can be held in a closed position by way of an adhesive strip located on the either or both panels, such that once the panels are brought into opposition, the contact between the sample application pads and the test element is maintained.

Preferably, the sample receiving panel and the testing panel are able to engage one another by means of a releasable hinge: A releasable hinge may include any means by which the sample receiving panel is able to engage or be engaged by the testing panel in such a way as to allow the two panels to become temporarily and preferably rigidly connected when desired, and also allow the two panels to become released or detached from one another when desired. By way of example, the edge of one side of the sample receiving panel and the edge of one side of the testing panel may engage one another by way of a detachable hinge. The detachable hinge may include any hinging means, such as for example, a hook and a catch or a flexible connector that connects the panels by way of an adhesive tape or other similar flexible connectors. Preferably, the detachable hinge means includes a male connector and a female connector, wherein the male connector includes a flexible protrusion, for example on the testing panel, and the female connector includes an aperture or a void, for example in the sample receiving panel.

One preferred embodiment may include a positionable and/or removable protective shielding member that is moisture resistant, such as for example a plastic shield, which covers the one or more sample application pads, so as to minimize any undesirable contact with the sample or samples that have been deposited onto the sample application pads. One or more of the present embodiments may also include a protective shielding member that is moisture resistant and partially covers the test element. With respect to the test element, only a partial shielding is preferred so as to allow contact with the testing element only in the desired locations, for example the location of contact for the sample application pads, and allowing visual observation of the test result in the proper location of the test element. In certain embodiments the protective shield may be clear such that the test site may be covered by the protective shield allowing observation of the test result through the clear protective shield. The protective shield of the test element can also minimize any undesirable contact or contamination of the test element while in use or otherwise.

In one preferred embodiment, the testing element comprises an immunochromatographic test strip capable of detecting and/or quantitative measuring the one or more analytes of interest, wherein the immunochromatographic test strip includes one or more labeled ligands capable of detecting the one or more analytes of interest. Immunochromatograhic test strips are well known by those reasonably skilled in the. Preferred immunochromatographic test strips include, for example, a liquid conductive test strip able to allow migration of the sample through the immunochromatographic test strip by way of capillary flow. The liquid conductive immunochromatograhic test strip may include immoblized thereto a capture, detection, or binding reagent able to determine the one or more analaytes of interest either directly or indirectly. One or more mobilizable labeled ligands, such as for example antibodies, specific for the one or more analytes of interest may be glazed onto and/or impregnated within the test strip, or be provided on a conjugate pad, or be pre-mixed with the one or more samples, or be pre-mixed with any solvent used to rehydrate, resolublize, or resuspend the one or more samples.

In certain preferred embodiments, the immunochromatographic test strip may include a contact zone which contacts the one or more sample application pads and allows liquid communication when the sample receiving panel and the testing panel are brought into opposition. Once the sample receiving panel and the testing panel are opposingly contacted, the contact between the sample application pads and the test element is preferably direct-liquid communication, although indirect liquid communications are also contemplated and additional elements may be incorporated.

Preferably, the sample receiving panel includes an observation aperture capable of allowing visual observation of the test result zone of the immunochromatographic test strip when the sample receiving panel and the testing panel are brought into opposition in order to allow testing to proceed. One or more of the present embodiments may preferably further include one or more solvent application apertures located on the sample receiving panel or the sample testing panel or both for bringing a solvent in contact with the one or more sample application pads in order to rehydrate, resolublize, or resuspend the one or more samples and conduct, transfer, or carry the rehydrated, resolublized, or resuspended one or more samples from the one or more sample application pads to the immunochromatographic test strip.

II. Another Sample Receiving Device

One or more of the present embodiments relates to a sample receiving device and methods of use thereof for the collection and testing of test samples, where the collection of the test sample(s) and the testing of the test sample(s) are separate activities and utilize separate parts of the receiving test device.

One or more of the present embodiments include a transportable sample receiving device including means for receiving a sample suspected of containing one or more analytes of interest. The means for receiving a sample can be constructed in any suitable way where a sample can be applied to and collected by the means for receiving a sample. Preferably the means for receiving a sample includes one or more sample application pads that are able to receive and collect applied sample. The means for receiving a sample may be very simple and only include the one or more sample application pads, but preferably, the means for receiving a sample provides a moisture-resistant backing onto which the sample application pads are fixedly attached. The one or more sample application pads may be made of any material able to accept a sample and the selection of the material depends on the type of sample which is to be applied to the sample application pads. Preferably, the one or more sample application pads are made of one or more porous materials that can accept liquid, semisolid, and solid samples.

One or more of the present embodiments also include means for testing the sample collected by the means for receiving a sample, wherein the means for testing is capable of determining the presence or absence of or measuring the amount of the one or more analytes of interest in the sample. The means for testing may be provided in a variety of embodiments, preferably, one or more immunochromatographic test strips, such as for example, immunochromatograhic test strip that are capable of detecting and/or quantitative measuring the one or more analytes of interest, wherein the immunochromatographic test strip includes one or more labeled ligands capable of detecting the one or more analytes of interest. Immunochromatograhic test strips are well known by those reasonably skilled in the art. The means for testing may be very simple and only include the one or more immonochromatographic test strips, but preferably, the means for testing provides a moisture-resistant backing onto which the one or more immunochromatograhic test strips are fixedly attached.

Preferably, the means for receiving and the means for testing are able to engage one another by means of a releasable hinge. A releasable hinge may include any means by which the means for receiving is able to engage or be engaged by the means for testing in such a way as to allow the two to become temporarily and preferably rigidly connected when desired, and also allow the two to become released or detached from one another when desired. By way of example, the edge of one side of the means for receiving and the edge of one side of the means for testing may engage one another by way of a detachable hinge. The releasable hinge may include any hinging means, such as for example, a flexible connector that connects the means for receiving and the means for testing by way of an adhesive tape or other similar flexible connectors. Preferably, the releasable hinge means includes a male connector and a female connector, wherein the male connector includes a flexible protrusion, for example on the testing panel, and the female connector includes an aperture or a void, for example in the sample receiving panel.

Preferably, the means for testing is able to opposingly engage the means for receiving a sample, wherein, when the means for testing is brought into opposition with the means for receiving a sample through manual closure, and the one or more sample application pads of the means for receiving are brought into liquid communication with the one or more immunochromatographic test strips of the means for testing with sufficient applied pressure to transfer liquid from the sample application pads to the immunochromatographic test strip(s).

Certain preferred embodiment may include a positionable and/or removable protective shielding member that is moisture resistant and covers the one or more sample application pads of the means for receiving a sample, so as to minimize any undesirable contact with the sample or samples that have been deposited or collected onto the sample application pads. One or more of the present embodiments may also include a protective shielding member that is moisture resistant and partially covers the immunochromatographic test strip of the means for testing. With respect to the immunochromatographic test strip, only a partial shielding is preferred so as to allow contact with the test strip only in the desired locations, for example the location of contact for the sample application pads, and allowing visual observation of the test result in the proper location of the test strip. In certain embodiments the protective shield may be clear such that the test site may be covered by the protective shield allowing observation of the test result through the clear protective shield. The protective shield of the test strip can also minimize any undesirable contact or contamination of the test strip while in use or otherwise.

In certain preferred embodiments the immunochromatographic test strip may include a contact zone which contacts the one or more sample application pads and allows liquid communication when the means for receiving a sample and the means for testing are brought into opposition. Once the means for receiving a sample and the means for testing are opposingly contacted, the contact between the sample application pads and the immunochromatographic test strip is preferably direct-liquid communication, although indirect liquid communications are also contemplated and additional elements may be incorporated.

Preferably, the means for receiving a sample includes an observation aperture capable of allowing visual observation of the test result zone of the immunochromatographic test strip of the means for testing when the means for receiving a sample and the means for testing are brought into opposition in order to allow testing to proceed. One or more of the present embodiments may preferably further include one or more solvent application apertures located on the means for receiving a sample or the means for testing or both for bringing a solvent in contact with the one or more sample application pads in order to rehydrate, resolublize, or resuspend the one or more samples and conduct, transfer, or carry the rehydrated, resolublized, or resuspended one or more samples from the one or more sample application pads to the immunochromatographic test strip.

III. Methods for Detecting One or More Analytes of Interest in a Sample

One or more of the present embodiments relates to a sample receiving device and methods of use thereof for the collection and testing of test samples, where the collection of the test sample(s) and the testing of the test sample(s) are separate activities and utilize separate parts of the receiving test device.

One or more of the present embodiments includes a method for detecting one or more analytes of interest in a sample suspected of containing one or more analytes of interest including the steps of: a) providing a separable and opposable sample receiving member comprising one or more sample application pads; b) applying said sample to said one or more sample application pads; c) providing a separable and opposable testing member comprising an immunochromatographic test strip capable of detecting and/or quantitative measuring said one or more analytes of interest, wherein said separable and opposable testing member is able to opposingly engage said separable and opposable sample receiving member by means of a detachable hinge; and d) bringing said sample receiving member and said testing member into opposition such that said one or more sample application pads of said sample receiving member are brought into liquid communication with said immunochromatographic test strip of said testing member.

Preferably, the separable and opposable sample receiving member-and the separable and opposable testing member are able to engage one another by means of a releasable hinge. A releasable hinge may include any means by which the sample receiving member is able to engage or be engaged by the testing member in such a way as to allow the two members to become temporarily and preferably rigidly connected when desired, and also allow the two members to become released or detached from one another when desired. By way of example, the edge of one side of the separable and opposable sample receiving member and the edge of one side of the separable and opposable testing member may engage one another by way of a detachable hinge. The detachable hinge may include any hinging means, such as for example, a flexible connector that connects the separable and opposable sample receiving member and the separable and opposable testing member by way of an adhesive tape or other similar flexible connectors. Preferably, the detachable hinge means includes a male connector and a female connector, wherein the male connector includes a flexible protrusion, for example on the sample testing member, and the female connector includes an aperture or a void, for example in the sample receiving member.

Preferably, the releasable and opposable sample receiving member is able to opposingly engage the releasable and opposable testing member, wherein, when the sample receiving member is brought into opposition with the testing member through manual closure, and the one or more sample application pads of the receiving member are brought into liquid communication with the one or more immunochromatographic test strips of the testing member with sufficient applied pressure to transfer liquid from the sample application pads to the immunochromatographic test strip(s).

After proper incubation period and completion of the testing procedure, the results of the test can be visualized or read by the aid of a machine from the immunochromatographic test strip indicating the presence or absence of the analytes of interest or measuring the amount of the one or more analytes of interest in the sample.

### EXAMPLES

### Example I

### A Sample Receiving Device

This Example provides one embodiment of the sample receiving device having a sample receiving member 100 comprising a sample receiving panel 101. The sample receiving panel 101 includes one or more sample application pads 102 for collection of the desired sample that is suspected of containing one or more analytes of interest for testing. The sample receiving panel 101 also includes a female connector 103 comprising a void in the sample receiving panel 101, and an observation aperture 104 that allows visual observation of the test result.

This embodiment also includes a testing member 300 comprising a testing panel 301. In the present example, the testing panel 301 includes an immunochromatographic test strip 302 as the testing element, which is able to determine the one or more anlalytes of interest suspected of being present in the sample. In the present example, the testing panel 301 of the sample receiving device includes a flexible male connector 303 capable of acting as a releasable hinge and bending at the line of attachment to the body of the testing panel 301. The male connector 303 of the present example includes an observation aperture 304 that can line up with the observation aperture 104 of the sample receiving panel 101 in order to allow visual observation on the test result of the immunochromatographic test strip 302. The testing panel 301 of the present example includes an adhesive strip 305 on one side of the testing panel 301 which keeps the device in the closed position during the testing procedure.

The test panel 301 of the sample receiving device is able to opposingly engage the sample receiving panel 101 by way the male connector 303 of the test panel 301 which can be inserted in the female connector 103 of the sample receiving panel 101 and be kept in place by way of extending lips (shown by dotted lines) which partially covers and keeps in place the male connector 303 of the testing panel 301. When the sample receiving panel 101 is brought into opposition with the testing panel 301 through manual closure, and kept in place by the adhesive strip 305, the one or more sample application pads 102 of the sample receiving panel 101 are brought into liquid communication with the immunochromatographic test strip 302 of the testing panel 301 with sufficient applied pressure to transfer liquid from the sample application pads 102 to the immunochromatographic test strip 302 and allow the testing of the sample to proceed.

All headings are for the convenience of the reader and should not be used to limit the meaning of the text that follows the heading, unless so specified. Various changes and departures may be made to the sample receiving device without departing from the spirit and scope thereof. Accordingly, it is not intended that the invention be limited to that specifically described in the specification or as illustrated in the drawings, but only as set forth in the claims.

What is claimed is:

1. A transportable sample receiving device comprising:
a sample receiving member comprising one or more sample application pads able to accept one or more samples suspected of containing one or more analytes of interest; and
a testing member comprising one or more test elements capable of determining the presence or absence of, or measuring the amount of said one or more analytes of interest, said testing member able to opposingly engage said sample receiving member;
wherein, when said sample receiving member is brought into opposition with said testing member, said one or more sample application pads of said sample receiving member are brought into liquid communication with said one or more testing elements of said testing.

2. The device of claim 1, wherein said sample receiving member comprises a sample receiving panel comprising a front side and a rear side wherein said one or more sample application pads are fixedly positioned on said front side of said sample receiving panel, and wherein said testing member comprises a testing panel comprising a front side and a rear side wherein said one or more testing element is fixedly positioned on said front side of said testing panel.

3. The device of claim 2, wherein said sample receiving panel and said testing panel are able to engage one another by means of a releasable hinge.

4. The device of claim 3, wherein said releasable hinge means comprises a male connector and a female connector.

5. The device of claim 3, wherein said sample receiving panel further comprising a positionable and/or removable protective shielding member which covers said one or more sample application pads.

6. The device of claim 3, wherein said one or more testing elements comprise one or more immunochromatographic test strips capable of detecting and/or quantitative measuring said one or more analytes of interest, said one or more immunochromatographic test strips comprising one or more labeled ligands capable of determining said one or more analytes of interest.

7. The device of claim 6, wherein said one or more immunochromatographic test strips comprises one or more contact zones which contact said one or more sample application pads and allow liquid communication when said sample receiving panel and said testing panel are brought into opposition.

8. The device of claim 6, wherein said sample receiving panel further comprises an observation aperture capable of allowing visual observation of said one or more immunochramatographic test strips when said sample receiving panel and said testing panel are brought into opposition.

9. The device of claim 6, further comprising one or more solvent application apertures on said sample receiving panel or said sample testing panel or both for bringing a solvent in contact with said one or more sample application pads in order to rehydrate, resolublize, or resuspend said one or more samples and conduct, transfer, or carry said rehydrated, resolublized, or resuspended one or more samples from said one or more sample application pads to said one or more immunochromatographic test strips.

10. The device of claim 6, wherein said testing panel further comprising one or more protective shielding members which partially cover said one or more immunochromatographic test strips.

11. A transportable sample receiving device comprising:
means for receiving a sample suspected of containing one or more analytes of interest; and
means for testing said sample capable of detecting and/or quantitative measuring said one or more analytes of interest, said means for testing able to opposingly engage said means for receiving a sample by means of a releasable hinge;
wherein, said means for receiving a sample and said means for testing said sample are able to opposingly engage one another such that when said means for receiving a sample and said means for testing said samples are brought into opposition, said means for receiving a sample is brought into liquid communication with said means for testing said sample.

12. The device of claim 11, wherein said means for receiving a sample comprises one or more sample application pads, and wherein said means for testing said sample comprises one or more immunochromatographic test strips capable of detecting and/or quantitative measuring said one or more analytes of interest.

13. The device of claim 12, wherein said releasable hinge means comprises a male connector and a female connector.

14. The device of claim 13, wherein said means for receiving a sample further comprises a positionable and/or removable protective shielding member which covers said one or more sample application pads, and wherein said means for receiving said sample further comprises one or more protective shielding members which partially cover said one or more immunochromatographic test strips.

15. The device of claim 14, wherein said one or more immunochromatographic test strips comprise one or more labeled ligands capable of determining said one or more analytes of interest.

16. The device of claim 15, wherein said one or more immunochromatographic test strip comprise one or more contact zones which contact said one or more sample application pads and allow liquid communication when said means for receiving a sample and said means for testing said sample are brought into opposition.

17. The device of claim 16, wherein said means for receiving a sample further comprises an observation aperture capable of allowing visual observation of said one or more immunochramatographic test strips when said means for receiving a sample and said means for testing said sample are brought into opposition.

18. The device of claim 17, further comprising one or more solvent application apertures on said means for receiving a sample or said means for receiving said sample or both for bringing a solvent into contact with said one or more sample application pads in order to rehydrate, resolublize, or resuspend said one or more samples and conduct, transfer, or carry said rehydrated, resolublized, or resuspended one or more samples from said one or more sample application pads to said one or more immunochromatographic test strips.

19. A method for determining the presence or absence of, or measuring the amount of one or more analytes of interest in a sample suspected of containing one or more analytes of interest comprising the steps of:
a) providing a separable and opposable sample receiving member comprising one or more sample application pads;
b) applying said sample to said one or more sample application pads;
c) providing a separable and opposable testing member comprising one or more immunochromatographic test strips capable of detecting and/or quantitative measuring said one or more analytes of interest, wherein said separable and opposable testing member is able to opposingly engage said separable and opposable sample receiving member by means of a releasable hinge;
d) bringing said sample receiving member and said testing member into opposition such that said one or more sample application pads of said sample receiving member are brought into liquid communication with said one or more immunochromatographic test strips of said testing member; and
e) detecting the presence or absence of or measuring the amount of said one or more analytes of interest in said sample

20. The method of claim 19, wherein said releasable hinge means comprises a male connector and a female connector.
